(19) United States
(12) Patent Application Publication
(10) Pub. No.: US 2026/0310363 A1
(43) Pub. Date: Oct. 8, 2026

(54) DEVICE, SYSTEM AND METHODS FOR INITIALIZATION OF CONFIGURABLE LOGIC BLOCKS

(71) Applicant: Microchip Technology Inc., Chandler, AZ (US)

(72) Inventors: John Day, Marlborough, MA (US); John Charais, Oconomowoc, WI (US); Hartono Darmawaskita, Chandler, AZ (US); Razvan Dochia, Bucharest (RO); Alex Calinescu, Bucuresti (RO); Teodor Calinovschi, Bucharest (RO)

(73) Assignee: Microchip Technology Inc., Chandler, AZ (US)

(21) Appl. No.: 19/279,320

(22) Filed: Jul. 24, 2025

Related U.S. Application Data
(60) Provisional application No. 63/782,686, filed on Apr. 3, 2025.

(51) Int. Cl. G06F 3/06

(52) U.S. Cl. CPC G06F 3/0632; G06F 3/0604; G06F 3/0679

(57) ABSTRACT

A device includes a flash memory, the flash memory including configurable logic block (CLB) configuration words, peripheral configuration words, a termination address, and program words. A state machine and a CPU may be coupled to the flash memory, and a CLB and a peripheral may be coupled to the state machine. In operation, as part of an initialization sequence, the state machine may read CLB configuration words and write the CLB configuration words to register space of the CLB and the state machine may read peripheral configuration words and write the peripheral configuration words to register space of the peripheral. At the conclusion of the initialization sequence, if the CPU is configured to begin operation, the CPU may execute one or more of the program words.

### PRIORITY

This application claims priority to commonly owned U.S. Provisional Patent Application 63/782,686 filed on Apr. 3, 2025, the entire contents of which are hereby incorporated by reference for all purposes.

### FIELD OF THE INVENTION

The present disclosure relates configuration of microcontroller units, and in particular to a device, system and method for initialization of configurable logic blocks via state machine.

### BACKGROUND

An electrical system may include one or more configurable logic blocks (CLB), which may be configured to implement one of many logic functions, including but not limited to an adder, a Boolean logic function, a flip-flop (FF) or other logic functions not specifically mentioned. A system may include one or more peripherals coupled to a microcontroller. The CLBs and the peripherals may both be configured at startup of the system or may be configured at a time requested by a processor or other circuit element.

System designers may spend significant time and effort writing firmware to configure and initialize the CLBs and peripherals. As new peripherals are added to a system, new firmware may be written and compiled. New firmware may require significant effort to qualify and validate before it may be deployed in a system.

There is a need for devices, systems, and methods to enable configuration and initialization of CLBs and peripherals without firmware development.

### SUMMARY

The examples herein enable devices, systems and methods for initialization of configurable logic blocks.

According to one aspect, a device includes a non-transitory flash memory, the non-transitory flash memory comprising one or more configurable logic block (CLB) configuration words, one or more peripheral configuration words, a termination address, and one or more program words. The device includes a state machine coupled to the non-transitory flash memory, a configurable logic block (CLB) coupled to the state machine, one or more peripherals coupled to the state machine, and a central processing unit (CPU) coupled to the non-transitory flash memory. In operation, the state machine comprises an initialization circuit, the initialization circuit to cause the state machine to read one or more configuration words from an initialization program. Based on the one or more configuration words, the state machine reads the one or more CLB configuration words from the non-transitory flash memory and writes the one or more CLB configuration words to the CLB, and reads the one or more peripheral configuration words from the non-transitory flash memory and writes the one or more peripheral configuration words to the one or more peripheral.

Aspects as in the preceding paragraph provide a device, wherein the one or more CLB configuration words comprise an address field, the address field to indicate a destination of the CLB configuration word.

Aspects as in the preceding two paragraph provide a device wherein the one or more peripheral configuration words comprise an address field, the address field to indicate a destination of respective peripheral configuration words.

Aspects as in the preceding three paragraphs provide a device, wherein a content of the termination address indicates an end of the one or more CLB configuration words and the one or more peripheral configuration words.

Aspects as in the preceding four paragraphs provide a device, wherein the initialization program comprises an initialization sequence to be performed when the device is powered up.

Aspects as in the preceding five paragraphs provide a device, wherein one or more configuration words specifies the CPU to execute the one or more program words after the initialization sequence is complete.

Aspects as in the preceding paragraphs provide a device, wherein the state machine to read the one or more CLB configuration words from the non-transitory flash memory and write the one or more CLB configuration words to one or more CLB setup registers.

Aspects as in the preceding paragraph provide a device, wherein the one or more CLB setup registers comprise a memory-mapped register space.

Aspects as in the preceding paragraphs provide a device, wherein the state machine to read the one or more peripheral configuration words from the non-transitory flash memory and write the one or more peripheral configuration words to one or more peripheral setup registers.

Aspects as in the preceding paragraphs provide a device, wherein the one or more peripheral setup registers comprise a memory-mapped register space.

According to one aspect, a system includes a non-transitory flash memory, the non-transitory flash memory comprising one or more configurable logic block (CLB) configuration words, one or more peripheral configuration words, a termination address, and one or more program words. The system includes a microcontroller coupled to the flash memory, the microcontroller comprising a state machine coupled to the non-transitory flash memory, a CLB coupled to the state machine, one or more peripherals coupled to the state machine, and a central processing unit (CPU) coupled to the non-transitory flash memory. The state machine comprises an initialization circuit, the initialization circuit to cause the state machine to read one or more microcontroller configuration words from an initialization program. Based on the one or more microcontroller configuration words, the state machine may read the one or more CLB configuration words from the non-transitory flash memory and write the one or more CLB configuration words to the CLB, and may read the one or more peripheral configuration words from the non-transitory flash memory and write the one or more peripheral configuration words to the one or more peripherals.

Aspects as in the preceding paragraph provide a system, wherein the state machine to read the one or more CLB configuration words from the non-transitory flash memory and write the one or more CLB configuration words to one or more CLB setup registers.

Aspects as in the preceding two paragraphs provide a system, wherein the one or more CLB setup registers comprise a memory-mapped register in a special function register.

Aspects as in the preceding three paragraphs provide a system, wherein the state machine to read the one or more peripheral configuration words from the non-transitory flash memory and write the one or more peripheral configuration words to one or more peripheral setup registers.

Aspects as in the preceding four paragraphs provide a system, wherein the one or more peripheral setup registers comprise a memory-mapped register in a special function register.

According to one aspect, a method includes steps of: initiating a power-up sequence, determining if a CLB configuration operation is enabled, configuring, if the CLB configuration operation is enabled, the CLB and one or more peripherals, determining if a CPU is configured to remain in a halted state after the power-up sequence, and running application code in the CPU if the CPU is not configured to remain in the halted state.

Aspects as in the preceding paragraph provide a method, wherein determining if a CLB configuration operation is enabled is based on a value in a configuration word.

Aspects as in the preceding two paragraphs provide a method, wherein configuring the CLB comprises reading a configuration word from a flash memory and writing the configuration word to a setup register in the CLB.

Aspects as in the preceding three paragraphs provide a method, wherein configuring the one or more peripherals comprises reading a configuration word from a flash memory and writing the configuration word to a setup register in the one or more peripherals.

Aspects as in the preceding four paragraphs provide a method, wherein determining if a CPU is configured to remain in a halted state is based on a value in a configuration word.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 illustrates one of various examples of a device for initialization of configurable logic blocks.

FIG. 2 illustrates a system for initialization of configurable logic blocks.

FIG. 3 illustrates a flow chart of a method of initialization of configurable logic blocks.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. It should be noted that the features illustrated in the drawings are not necessarily drawn to scale.

### DETAILED DESCRIPTION

Aspects combine a hardware update with a software configuration method to initialize Configurable Logic Blocks (CLBs) on an embedded microcontroller (MCU) before code execution. A state machine may retrieve information from the Program Flash Memory (PFM) and may load the necessary configurations into the CLB registers into peripheral registers. Additionally, there may be an option to select whether the central processing unit (CPU) itself will run and execute a desired program after the CLB and peripherals are configured, or if it will do nothing. If the CPU is set to do nothing, then the MCU chip will function like a programmable logic device (PLD).

Aspects provide an automated system that configures microcontroller peripherals at startup, or at another time, without requiring any firmware development. This system includes a state machine that retrieves configuration data from a flash memory and loads it into the CLBs and peripherals, enabling immediate operational readiness.

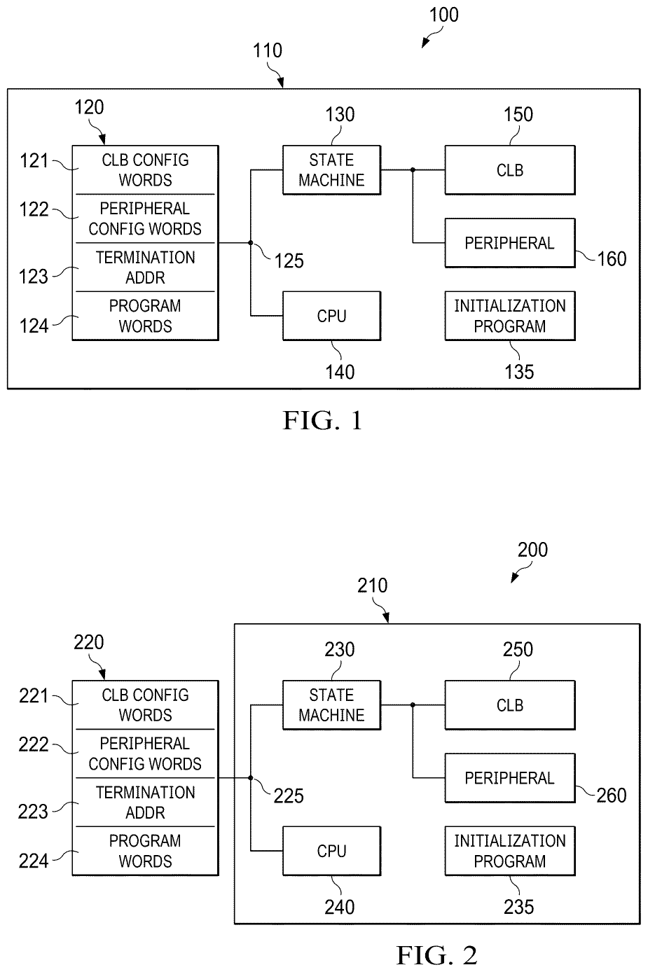

FIG. 1 illustrates one of various examples of a device 100 for initialization of configurable logic blocks.

Device 100 may include microcontroller 110. Microcontroller 110 may be implemented as any suitable type of control or processing unit capable of executing instructions and interfacing with peripheral components. Examples of microcontrollers include, but are not limited to, general-purpose microcontrollers, application-specific integrated microcontrollers, digital signal controllers, or system-on-chip (SoC) devices that incorporate one or more processing cores along with memory and input/output interfaces. Microcontroller 110 may include embedded flash memory, RAM, timers, analog-to-digital converters (ADCs), communication modules (such as UART, SPI, I²C, or CAN), and other integrated peripherals. In one of various examples, microcontroller 110 may be configured for low-power operation, real-time control, or integration within an embedded or distributed system.

Microcontroller 110 may include flash memory 120. Flash memory 120 may be a non-transitory flash memory and may be implemented as any suitable type of non-volatile memory configured to store data, instructions, or other information. Examples of flash memory include, but are not limited to, NAND flash, NOR flash, serial flash, embedded flash, or flash memory integrated within a system-on-chip (SoC). Flash memory 120 may be organized as single-level cell (SLC), multi-level cell (MLC), triple-level cell (TLC), or other configurations suitable for the intended performance and storage requirements. In one of various examples, flash memory 120 may serve as program memory, data storage, or configuration memory, and may be interfaced through parallel or serial protocols such as SPI, QSPI, or eMMC. Flash memory 120 may be internal or external to a microcontroller or processing unit, and may be partitioned into sectors, pages, or blocks as appropriate for erase and write operations. Flash memory 120 may be partitioned into one or more partitions, respective partitions storing different types of data.

As one of various examples, a first partition may store CLB configuration words 121. A second partition may store peripheral configuration words 122. A third partition may store a termination address 123. A fourth partition may store program words 124.

Flash memory 120 may be coupled to state machine 130 and to central processing unit (CPU) 140. Memory bus 125 may facilitate communication between flash memory 120, state machine 130 and CPU 140. Memory bus 125 may be implemented as any suitable communication pathway or interface configured to enable data transfer between processing components, such as a central processing unit (CPU), and memory components, such as flash memory 120. Memory bus 125 may include address lines, data lines, and control signals and may operate according to a variety of protocols and signaling standards. Examples of memory bus 125 include parallel memory interfaces (e.g., AMBA AHB/AXI, external memory interfaces for NOR/NAND flash), serial memory interfaces (e.g., SPI, QSPI), or proprietary memory access architectures. As one of various examples, memory bus 125 may support synchronous or asynchronous operation, burst access, or direct memory access (DMA) transfers. Memory bus 125 may also include error detection and correction capabilities, timing control logic, or arbitration mechanisms in multi-master systems.

CPU 140 and state machine 130 may read data from flash memory 120. State machine 130 may be coupled to configurable logic block (CLB) 150 and to Peripheral 160. Peripheral 160 may be implemented as any suitable hardware or functional module operably coupled to or integrated within the microcontroller and configured to perform a specific input/output, control, or communication function. Examples of peripheral 160 include, but are not limited to, communication interfaces such as Universal Asynchronous Receiver-Transmitter (UART), Serial Peripheral Interface (SPI), Inter-Integrated Circuit (I²C), Controller Area Network (CAN), or Universal Serial Bus (USB) modules; timing components such as timers, counters, or pulse-width modulation (PWM) units; analog interfaces such as analog-to-digital converters (ADCs) or digital-to-analog converters (DACs); and control interfaces for external devices such as motor drivers, display controllers, or general-purpose input/output (GPIO) ports. As one of various examples, peripheral 160 may be implemented as a standalone hardware block or as part of a shared peripheral subsystem, and may be configurable via firmware or programmable registers. CLB 150 may include one or more setup registers which may be called CLB setup registers.

Microcontroller 110 may include initialization program 135. Initialization program 135 may include one or more microcontroller configuration words, the one or more microcontroller configuration words specifying operation of state machine 130 and CPU 140. Initialization program 135 may include other configuration words to control operation of other components of microcontroller 110. In one of various examples, initialization program 135 may contain one or more microcontroller configuration words to be read as part of a power-up sequence. In other examples, the one or more microcontroller configuration words may be read based on input from CPU 140. In operation, an initialization circuit in state machine 130 may read one or more microcontroller configuration words from initialization program 135. The power-up sequence may include additional steps, including but not limited to monitoring a supply voltage, selecting an oscillator output, enabling one or more startup delays, implementing a brown-out detection mode, or other steps not specifically mentioned.

In one of various examples, an initialization sequence for device 100 may be initiated based on power applied to device 100. State machine 130 may read one or more microcontroller configuration words from initialization program 135, and if the microcontroller configuration words indicate that, upon powerup of device 100, state machine 130 is to load CLB 150 and peripheral 160 with initial data, then state machine 130 may sequentially read CLB configuration words 121 and peripheral configuration words 122 from flash memory 120 and may write, respectively, to CLB setup registers in CLB 150 and to peripheral setup registers in peripheral 160. CLB configuration words 121 may be written to CLB setup registers in CLB 150, and peripheral configuration words 122 may be written to peripheral setup registers in 160. An address field in CLB configuration words 121 may indicate the destination of each CLB configuration word and state machine 130 may route the CLB configuration word to the appropriate destination based on the address field. An address field in peripheral configuration words 122 may indicate the destination of each peripheral configuration word and state machine 130 may route the peripheral configuration word to the appropriate destination based on the address field. In other examples, the state machine may write CLB configuration words sequentially.

The example illustrated in FIG. 1 includes one peripheral 160, but this is not intended to be limiting. Registers within CLB 150 may be hard-coded registers or may be memory-mapped registers. Registers within CLB 150 may be memory-mapped special function registers. Registers within peripheral 160 may be memory-mapped registers. Registers within peripheral 160 may be memory-mapped special function registers.

In one of various examples, registers within CLB 150 may be hard-coded registers, and state machine 130 may directly store data into registers within CLB 150. CLB 150 may read data sequentially from flash memory 120 may store data sequentially in registers within CLB 150 and may not require address information to be stored in flash memory 120.

Termination address 123 may include an address field and may contain a unique data value in the address field to indicate the end of CLB configuration words 121 and peripheral configuration words 122. In one of various examples, termination address 123 may include data value 00h. In operation, when state machine 130 reads an address field equal to 00h, the initialization sequence is complete. In this manner, termination address 123 may indicate the end of the configuration space within flash memory 120. This example utilizing the data value 00h is merely for illustrative purposes and is not intended to be limiting.

In one of various examples, one or more microcontroller configuration words may indicate the operation of device 100 once the initialization sequence is complete. In one of various examples, one or more microcontroller configuration words may indicate that CPU 140 should be enabled after the initialization sequence is complete and CPU 140 may execute instructions stored in program words 124. In another example, one or more microcontroller configuration words may indicate that CPU 140 should remain idle after the initialization sequence is complete.

In this manner, CLB 150 and peripheral 160 may, upon initialization, be configured based on initialization program 135 and data stored in flash memory 120. No new firmware code is used in the initialization of device 100. As such, there may not be a lengthy firmware qualification process. This enables microcontroller peripherals to be configured with existing firmware, avoiding costly and time-consuming development and qualification for new firmware.

FIG. 2 illustrates a system 200 for initialization of configurable logic blocks.

System 200 may include microcontroller 210. Microcontroller 210 may be implemented as any suitable type of control or processing unit capable of executing instructions and interfacing with peripheral components. Examples of microcontrollers include, but are not limited to, general-purpose microcontrollers, application-specific integrated microcontrollers, digital signal controllers, or system-on-chip (SoC) devices that incorporate one or more processing cores along with memory and input/output interfaces. Microcontroller 210 may include embedded flash memory, RAM, timers, analog-to-digital converters (ADCs), communication modules (such as UART, SPI, I²C, or CAN), and other integrated peripherals. In one of various examples, microcontroller 210 may be configured for low-power operation, real-time control, or integration within an embedded or distributed system.

Microcontroller 210 may be coupled to flash memory 220. Flash memory may be external to microcontroller 210. Flash memory 220 may be a non-transitory flash memory and may be implemented as any suitable type of non-volatile memory configured to store data, instructions, or other information. Examples of flash memory include, but are not limited to, NAND flash, NOR flash, serial flash, embedded flash, or flash memory integrated within a system-on-chip (SoC). Flash memory 220 may be organized as single-level cell (SLC), multi-level cell (MLC), triple-level cell (TLC), or other configurations suitable for the intended performance and storage requirements. In one of various examples, flash memory 220 may serve as program memory, data storage, or configuration memory, and may be interfaced through parallel or serial protocols such as SPI, QSPI, or eMMC. Flash memory 220 may be external to microcontroller 210 and may be partitioned into sectors, pages, or blocks as appropriate for erase and write operations. Flash memory 220 may be partitioned into one or more partitions, respective partitions storing different types of data.

As one of various examples, a first partition of flash memory 220 may store CLB configuration words 221. A second partition may store peripheral configuration words 222. A third partition may store a termination address 223. A fourth partition may store program words 224.

Flash memory 220 may be coupled to state machine 230 and to central processing unit (CPU) 240. Memory bus 225 may facilitate communication between flash memory 220, state machine 230 and CPU 240. Memory bus 225 may be implemented as any suitable communication pathway or interface configured to enable data transfer between processing components, such as a central processing unit (CPU), and memory components, such as flash memory 220. Memory bus 225 may include address lines, data lines, and control signals and may operate according to a variety of protocols and signaling standards. Examples of memory bus 225 include parallel memory interfaces (e.g., AMBA AHB/AXI, external memory interfaces for NOR/NAND flash), serial memory interfaces (e.g., SPI, QSPI), or proprietary memory access architectures. As one of various examples, memory bus 225 may support synchronous or asynchronous operation, burst access, or direct memory access (DMA) transfers. Memory bus 225 may also include error detection and correction capabilities, timing control logic, or arbitration mechanisms in multi-master systems. Memory bus 225 is illustrated as a shared bus, but in other examples, system 200 may include a direct connection between flash memory 220 and state machine 230 and another direct connection between CPU 240 and flash memory 220.

CPU 240 and state machine 230 may read data from flash memory 220. State machine 230 may be coupled to configurable logic block (CLB) 250 and to peripheral 260. Peripheral 260 may be implemented as any suitable hardware or functional module operably coupled to or integrated within the microcontroller and configured to perform a specific input/output, control, or communication function. Examples of peripheral 260 include, but are not limited to, communication interfaces such as Universal Asynchronous Receiver-Transmitter (UART), Serial Peripheral Interface (SPI), Inter-Integrated Circuit (I²C), Controller Area Network (CAN), or Universal Serial Bus (USB) modules; timing components such as timers, counters, or pulse-width modulation (PWM) units; analog interfaces such as analog-to-digital converters (ADCs) or digital-to-analog converters (DACs); and control interfaces for external devices such as motor drivers, display controllers, or general-purpose input/output (GPIO) ports. As one of various examples, peripheral 260 may be implemented as a standalone hardware block or as part of a shared peripheral subsystem, and may be configurable via firmware or programmable registers. CLB 250 may include one or more setup registers which may be termed CLB setup registers.

Microcontroller 210 may include initialization program 235. Initialization program 235 may include one or more microcontroller configuration words, the one or more microcontroller configuration words specifying operation of state machine 230 and CPU 240. Initialization program 235 may include other configuration words to control operation of other components of microcontroller 210. In one of various examples, one or more microcontroller configuration words in initialization program 235 may be read after device 200 is powered up. In other examples, the initialization program may read one or more microcontroller configuration words based on input from CPU 240. In operation, an initialization circuit in state machine 230 may read one or more microcontroller configuration words from initialization program 235. In one of various examples, initialization program 235 may contain one or more microcontroller configuration words to be read as part of a power-up sequence. The power-up sequence may include additional steps, including but not limited to monitoring a supply voltage, selecting an oscillator output, enabling one or more startup delays, implementing a brown-out detection mode, or other steps not specifically mentioned.

Microcontroller 210 may include initialization program 235. Initialization program 235 may include one or more microcontroller configuration words, the one or more microcontroller configuration words specifying operation of state machine 230 and CPU 240 when system 200 is powered up. In operation, an initialization circuit in state machine 230 may read one or more microcontroller configuration words in initialization program 235. Initialization program 235 may comprise one or more microcontroller configuration words.

In one of various examples, an initialization sequence for system 200 may be initiated based on power applied to system 200. State machine 230 may read one or more microcontroller configuration words from initialization program 235, and if the microcontroller configuration words indicate that, upon powerup of system 200, state machine 230 is to load CLB 250 and peripheral 260 with initial data, then state machine 230 may sequentially read CLB configuration words 221 and peripheral configuration words 222 from flash memory 220 and may write, respectively, to CLB setup registers in CLB 250 and peripheral setup registers in peripheral 260. CLB configuration words 221 may be written to CLB setup registers in CLB 250, and peripheral configuration words 222 may be written to peripheral setup registers in peripheral 260. An address field in CLB configuration words 221 may indicate the destination of each CLB configuration word and state machine 230 may route the CLB configuration word to the appropriate destination based on the address field. An address field in peripheral configuration words 222 may indicate the destination of each peripheral configuration word and state machine 230 may route the peripheral configuration word to the appropriate destination based on the address field.

The example illustrated in FIG. 2 includes a single peripheral 260, but this is not intended to be limiting. Registers within CLB 250 may be hard-coded registers or may be memory-mapped registers. Registers within CLB 250 may be memory-mapped special function registers (SFRs). Registers within peripheral 260 may be hard-coded registers or may be memory-mapped registers. Registers within peripheral 260 may be memory-mapped special function registers.

Termination address 223 may include an address field and may contain a unique data value in the address field to indicate the end of CLB configuration words 221 and peripheral configuration words 222. In one of various examples, termination address 223 may include data value 00h. In operation, when state machine 230 reads an address field equal to 00h, the initialization sequence is complete. In this manner, termination address 223 may indicate the end of the configuration space within flash memory 220.

Initialization program 235 may include one or more microcontroller configuration words to indicate the operation of system 200 once the initialization sequence is complete. In one of various examples, initialization program 235 may indicate that CPU 240 should be enabled after the initialization sequence is complete and CPU 240 may execute instructions stored in program words 224. In another example, initialization program 235 may indicate that CPU 240 should remain idle after the initialization sequence is complete.

In this manner, CLB 250 and peripheral 260 may, upon initialization, be configured based on initialization program 235 and data stored in flash memory 220. No new firmware code is used in the initialization of system 200. As such, there may not be a lengthy firmware qualification process. This enables microcontroller peripherals to be configured with existing firmware, avoiding costly and time-consuming development and qualification for new firmware.

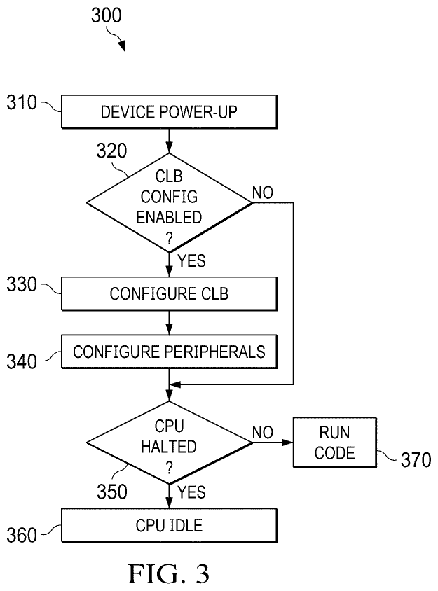

FIG. 3 illustrates a flow chart of a method of initialization of configurable logic blocks.

At operation 310, a device power-up sequence may be initiated. The power-up sequence may be initiated by the application of a power supply voltage, the release of a reset signal, a write to an enable register, or another method not specifically mentioned.

At operation 320, a comparator or other circuit or software component may determine if a CLB configuration operation is enabled. In one of various examples, a bit in a microcontroller configuration word may determine if the CLB configuration operation is enabled. If the CLB configuration operation is enabled, operation may continue to operation 330. If the CLB configuration operation is not enabled, operation may continue to operation 350.

At operation 330, the CLB may be configured. The configuration of the CLB may be via a state machine loading of flash memory contents into the CLB as described and illustrated in reference to FIG. 1.

At operation 340, one or more peripherals may be configured. In one of various examples, a state machine may load one or more configuration words to registers in the one or more peripherals. Configuration may continue until the state machine reaches a termination address indicating the end of the configuration space.

At operation 350, a comparator or other circuit or software component may determine if the CPU is to remain in a halted state after initialization. In one of various examples, a microcontroller configuration word may include a bit to specify if the CPU should remain in a halted state after initialization or if the CPU should begin operation after initialization. If the CPU is to remain in a halted state, operation may continue to operation 360, and at operation 360 the CPU may be held in the halted or idle state.

If the CPU is not to remain in a halted state, operation may continue to operation 370 and the CPU may run application code. The application code may be program words stored in a flash memory or may be program information stored in another type of memory component.

Although examples have been described above, other variations and examples may be made from this disclosure without departing from the spirit and scope of these disclosed examples.

1. A device comprising:
a non-transitory flash memory, the non-transitory flash memory comprising:
one or more configurable logic block (CLB) configuration words;
one or more peripheral configuration words;
a termination address;
one or more program words;
a state machine coupled to the non-transitory flash memory;
a CLB coupled to the state machine;
one or more peripherals coupled to the state machine, and
a central processing unit (CPU) coupled to the non-transitory flash memory,
wherein the state machine comprises an initialization circuit, the initialization circuit to cause the state machine to read one or more microcontroller configuration words from an initialization program, and based on the one or more microcontroller configuration words, to:
read the one or more CLB configuration words from the non-transitory flash memory and write the one or more CLB configuration words to the CLB, and
read the one or more peripheral configuration words from the non-transitory flash memory and write the one or more peripheral configuration words to the one or more peripherals.

2. The device as claimed in claim 1, wherein the one or more CLB configuration words comprise an address field, the address field to indicate a destination of the CLB configuration word.

3. The device as claimed in claim 1, wherein the one or more peripheral configuration words comprise an address field, the address field to indicate a destination of respective peripheral configuration words.

4. The device as claimed in claim 1, wherein a content of the termination address indicates an end of the one or more CLB configuration words and the one or more peripheral configuration words.

5. The device as claimed in claim 1, wherein the initialization program comprises one or more microcontroller configuration words to be read as part of a power-up sequence.

6. The device as claimed in claim 5, wherein one or more microcontroller configuration words specifies the CPU to execute the one or more program words after the initialization sequence is complete.

7. The device as claimed in claim 1, wherein the state machine to read the one or more CLB configuration words from the non-transitory flash memory and write the one or more CLB configuration words to one or more CLB setup registers.

8. The device as claimed in claim 7, wherein the one or more CLB setup registers comprise a memory-mapped register space.

9. The device as claimed in claim 1, wherein the state machine to read the one or more peripheral configuration words from the non-transitory flash memory and write the one or more peripheral configuration words to one or more peripheral setup registers.

10. The device as claimed in claim 9, wherein the one or more peripheral setup registers comprise a memory-mapped register space.

11. A system comprising:
a non-transitory flash memory, the non-transitory flash memory comprising:
one or more configurable logic block (CLB) configuration words;
one or more peripheral configuration words;
a termination address;
one or more program words;
a microcontroller coupled to the flash memory, the microcontroller comprising:
a state machine coupled to the non-transitory flash memory;
a CLB coupled to the state machine;
one or more peripherals coupled to the state machine, and
a central processing unit (CPU) coupled to the non-transitory flash memory,
wherein the state machine comprises an initialization circuit, the initialization circuit to cause the state machine to read one or more microcontroller configuration words from an initialization program, and based on the one or more microcontroller configuration words, to:
read the one or more CLB configuration words from the non-transitory flash memory and write the one or more CLB configuration words to the CLB, and
read the one or more peripheral configuration words from the non-transitory flash memory and write the one or more peripheral configuration words to the one or more peripherals.

12. The system as claimed in claim 11, wherein the state machine to read the one or more CLB configuration words from the non-transitory flash memory and write the one or more CLB configuration words to one or more CLB setup registers.

13. The system as claimed in claim 12, wherein the one or more CLB setup registers comprise a memory-mapped register in a special function register.

14. The system as claimed in claim 11, wherein the state machine to read the one or more peripheral configuration words from the non-transitory flash memory and write the one or more peripheral configuration words to one or more peripheral setup registers.

15. The system as claimed in claim 14, wherein the one or more peripheral setup registers comprise a memory-mapped register in a special function register.

16. A method comprising:
initiating a power-up sequence;
determining if a CLB configuration operation is enabled;
configuring, if the CLB configuration operation is enabled, the CLB and one or more peripherals;
determining if a CPU is configured to remain in a halted state after the power-up sequence; and
running application code in the CPU if the CPU is not configured to remain in the halted state.

17. The method as claimed in claim 16, wherein determining if a CLB configuration operation is enabled is based on a value in a microcontroller configuration word.

18. The method as claimed in claim 16, wherein configuring the CLB comprises reading a configuration word from a flash memory and writing the configuration word to a setup register in the CLB.

19. The method as claimed in claim 16, wherein configuring the one or more peripherals comprises reading a configuration word from a flash memory and writing the configuration word to a setup register in the one or more peripherals.

20. The method as claimed in claim 16, wherein determining if a CPU is configured to remain in a halted state is based on a value in a microcontroller configuration word.
